(19) United States
(12) Patent Application Publication
(10) Pub. No.: US 2023/0266653 A1
(43) Pub. Date: Aug. 24, 2023

(54) ILLUMINATOR AND PROJECTOR

(71) Applicant: SEIKO EPSON CORPORATION, Tokyo (JP)

(72) Inventors: Toshiaki HASHIZUME, Okaya-shi (JP); Akira SHINBO, Shiojiri-Shi (KR); Tomohiro YOKOO, Matsumoto-Shi (JP)

(21) Appl. No.: 18/170,616

(22) Filed: Feb. 17, 2023

(30) Foreign Application Priority Data
Feb. 18, 2022 (JP) 2022-023579

(51) Int. Cl. G03B 21/20; G03B 21/16

(52) U.S. Cl. CPC G03B 21/204; G03B 21/2066; G03B 21/16

(57) ABSTRACT

An illuminator includes a light source that emits first light that belongs to a first wavelength band, a wavelength converter that converts the first light into second light that belongs to a second wavelength band different from the first wavelength band, and an optical element that transmits the second light emitted from the wavelength converter. An air layer is provided between the wavelength converter and the optical element. A length of the air layer along the direction of the optical axis of the optical element is greater than or equal to 0.3 μm but smaller than or equal to 9.0 μm. The optical element has a coefficient of linear expansion smaller than or equal to 65×10⁻⁷/° C. at temperatures ranging from 100° C. to 200° C., and a thermal conductivity greater than or equal to 1.0 W/m·K.

The present application is based on, and claims priority from JP Application Serial Number 2022-023579, filed Feb. 18, 2022, the disclosure of which is hereby incorporated by reference herein in its entirety.

### BACKGROUND

### 1. Technical Field

The present disclosure relates to an illuminator and a projector.

### 2. Related Art

As an illuminator used in a projector, there has been a proposed illuminator using fluorescence emitted from a phosphor when the phosphor is irradiated with excitation light outputted from a light emitter.

JP-A-2017-215549 discloses an illuminator including a light source that outputs excitation light, a wavelength converter that converts the excitation light into fluorescence, and a pickup lens that transmits the fluorescence from the wavelength converter to a downstream optical system. Alight scattering layer having a plurality of recesses is provided at the surface, of the wavelength converter, that faces the pickup lens.

In the illuminator disclosed in JP-A-2017-215549, the fluorescence emitted from the wavelength converter is scattered by the light scattering layer and then enters the pickup lens. Out of the fluorescence that exits out of the light scattering layer, however, a portion of the fluorescence incident on the light incident surface of the pickup lens at a large angle of incidence is reflected off the light incident surface and cannot enter the pickup lens. As a result, the portion of the fluorescence emitted from the wavelength converter is lost, resulting in a possible decrease in the fluorescence utilization efficiency.

### SUMMARY

To solve the problem described above, an illuminator according to an aspect of the present disclosure includes a light source that emits first light that belongs to a first wavelength band, a wavelength converter that converts the first light into second light that belongs to a second wavelength band different from the first wavelength band, and an optical element that transmits the second light emitted from the wavelength converter. An air layer is provided between the wavelength converter and the optical element. A length of the air layer along a direction of an optical axis of the optical element is greater than or equal to 0.3 μm but smaller than or equal to 9.0 μm. The optical element has a coefficient of linear expansion smaller than or equal to 65×10⁻⁷/° C. at temperatures ranging from 100° C. to 200° C., and a thermal conductivity greater than or equal to 1.0 W/m·K.

A projector according to another aspect of the present disclosure includes the illuminator described above, a light modulator that modulates light emitted from the illuminator and containing the second light, and a projection optical apparatus that projects the light modulated by the light modulator.

### BRIEF DESCRIPTION OF THE DRAWINGS

FIG. 1 is a schematic configuration diagram of a projector according to a first embodiment.

FIG. 2 is a schematic configuration diagram of an illuminator according to the first embodiment.

FIG. 3 is a cross-sectional view of a wavelength conversion apparatus in the first embodiment.

FIG. 4 shows graphs illustrating the relationship of the distance between a wavelength converter and an optical element with the transmittance of a light incident surface of the optical element in the case where the angle of incidence is 45°.

FIG. 5 shows graphs illustrating the relationship of the distance between the wavelength converter and the optical element with the transmittance of the light incident surface of the optical element in the case where the angle of incidence is 35°.

FIG. 6 is a schematic configuration diagram of the wavelength conversion apparatus according to Comparative Example 1.

FIG. 7 is a schematic configuration diagram of the wavelength conversion apparatus according to Comparative Example 2.

FIG. 8 is a cross-sectional view of the wavelength conversion apparatus in a second embodiment.

### DESCRIPTION OF EXEMPLARY EMBODIMENTS

### First Embodiment

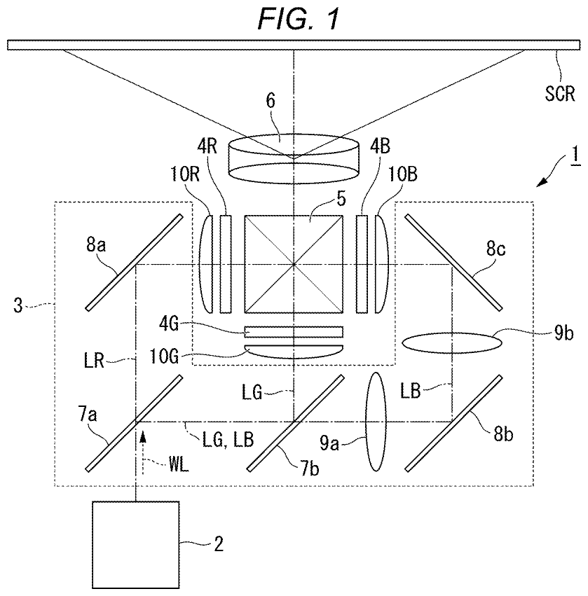

A first embodiment of the present disclosure will be described below with reference to FIGS. 1 to 5.

In the following drawings, components may be drawn at different dimensional scales for clarification of each of the components.

An example of a projector according to the present embodiment will be described.

FIG. 1 is a schematic configuration diagram of the projector according to the present embodiment.

A projector 1 according to the present embodiment is a projection-type image display apparatus that displays color video images on a screen SCR, as shown in FIG. 1. The projector 1 includes an illuminator 2, a color separation system 3, light modulators 4R, 4G, and 4B, a light combining system 5, and a projection optical apparatus 6. The configuration of the illuminator 2 will be described later.

The color separation system 3 includes a first dichroic mirror 7a, a second dichroic mirror 7b, reflection mirrors 8a, 8b, and 8c, and relay lenses 9a and 9b. The color separation system 3 separates illumination light WL outputted from the illuminator 2 into red light LR, green light LG, and blue light LB, guides the red light LR to the light modulator 4R, guides the green light LG to the light modulator 4G, and guides the blue light LB to the light modulator 4B.

A field lens 10R is disposed between the color separation system 3 and the light modulator 4R, substantially parallelizes the red light LR, and causes the resultant light to exit toward the light modulator 4R. A field lens 10G is disposed between the color separation system 3 and the light modulator 4G, substantially parallelizes the green light LG, and causes the resultant light to exit toward the light modulator 4G. A field lens 10B is disposed between the color separation system 3 and the light modulator 4B, substantially parallelizes the blue light LB, and causes the resultant light to exit toward the light modulator 4B.

The first dichroic mirror 7a transmits the red light LR and reflects the green light LG and the blue light LB. The second dichroic mirror 7b reflects the green light LG and transmits the blue light LB. The reflection mirror 8a reflects the red light LR. The reflection mirrors 8b and 8c each reflect the blue light LB.

The red light LR having passed through the first dichroic mirror 7a is reflected off the reflection mirror 8a, passes through the field lens 10R, and is incident on an image formation region of the light modulator 4R for red light. The green light LG reflected off the first dichroic mirror 7a is further reflected off the second dichroic mirror 7b, passes through the field lens 10G, and is incident on the image formation region of the light modulator 4G for green light. The blue light LB having passed through the second dichroic mirror 7b travels via the relay lens 9a, the reflection mirror 8b, the relay lens 9b, the reflection mirror 8c, and the field lens 10B and is incident on the image formation region of the light modulator 4B for blue light.

The light modulators 4R, 4G, and 4B each modulate the color light incident thereon in accordance with image information to form image light. The light modulators 4R, 4G, and 4B are each formed of a liquid crystal light valve. Although not shown, a light-incident-side polarizer is disposed on the light incident side of each of the light modulators 4R, 4G, and 4B. A light-exiting-side polarizer is disposed on the light exiting side of each of the light modulators 4R, 4G, and 4B.

The light combining system 5 combines the image light outputted from the light modulator 4R, the image light outputted from the light modulator 4G, and the image light outputted from the light modulator 4B with one another to form full-color image light. The light combining system 5 is formed of a cross dichroic prism formed of four right-angled prisms bonded to each other. Dielectric multilayer films are formed along the substantially X-letter-shaped interfaces between the right-angled prisms bonded to each other.

The image light having exited out of the light combining system 5 is enlarged and projected by the projection optical apparatus 6 to form an image on the screen SCR. That is, the projection optical apparatus 6 projects the light modulated by the light modulators 4R, 4G, and 4B. The projection optical apparatus 6 is formed of a plurality of projection lenses.

An example of the illuminator 2 according to the present embodiment will be described.

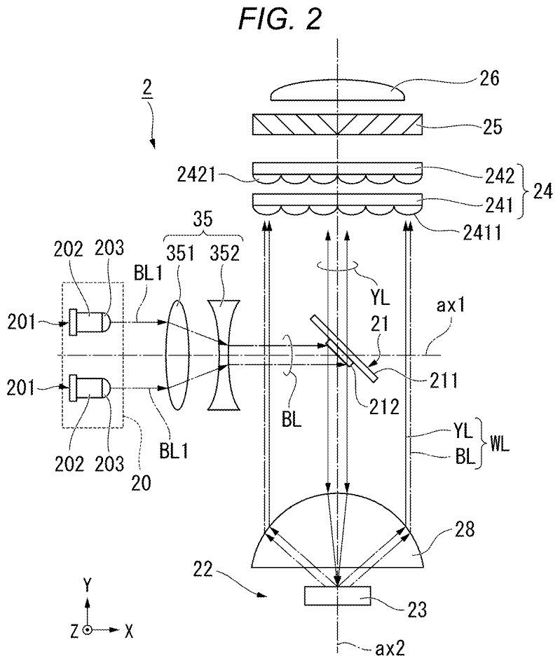

In the following description, an XYZ orthogonal coordinate system is used in FIG. 2. An axis parallel to the chief ray of blue light BL outputted from a light source apparatus 20 is defined as an axis X. An axis parallel to the chief ray of fluorescence YL emitted from a wavelength converter 23 is defined as an axis Y. The axis perpendicular to the axes X and Y is defined as an axis Z.

An axis along the chief ray of the blue light BL outputted from the light source apparatus 20 is referred to as an optical axis ax1 of the light source apparatus 20. That is, the optical axis ax1 of the light source apparatus 20 is parallel to the axis X. The axis along the chief ray of the fluorescence YL emitted from the wavelength converter 23 is referred to as an optical axis ax2 of the wavelength converter 23. That is, the optical axis ax2 of the wavelength converter 23 is parallel to the axis Y.

FIG. 2 is a plan view showing a schematic configuration of the illuminator 2 viewed in the axis-Z direction.

The illuminator 2 according to the present embodiment includes the light source apparatus 20, an afocal system 35, a light separator 21, a wavelength conversion apparatus 22, an optical integration system 24, a polarization converter 25, and a superimposing lens 26, as shown in FIG. 2. In FIG. 2, only the wavelength converter 23 and an optical element 28 are shown as the wavelength conversion apparatus 22, and the other components are omitted. The configuration of the wavelength conversion apparatus 22 will be described later in detail.

The light source apparatus 20 includes a plurality of light sources 201. In the present embodiment, the light source apparatus 20 includes four light sources 201. The four light sources 201 are arranged separately from each other in two rows and two columns along the axes Y and Z. The light source apparatus 20 outputs the blue light BL, which belongs to a first wavelength band. The number of light sources 201, which form the light source apparatus 20, is not limited to a specific number, and the arrangement of the light sources 201 is not limited to a specific arrangement.

The light sources 201 are each formed of a blue semiconductor laser and outputs blue light BL1, which belongs to the first wavelength band. The blue semiconductor laser outputs the blue light BL1, which belongs to the first wavelength band having a peak wavelength that falls within a range, for example, from 380 to 495 nm. The light source apparatus 20 therefore outputs four beams of the blue light BL1 as a whole. In the present specification, the four beams of the blue light BL1 are collectively referred to as the blue light BL, and the center axis of the entire four beams of the blue light BL1 is referred to as the chief ray of the blue light BL. As will be described later, part of the blue light BL functions as excitation light that excites a phosphor contained in the wavelength converter 23. The blue light BL1 in the present embodiment corresponds to the first light in the claims.

In the present embodiment, the light sources 201 each have a configuration in which one semiconductor laser chip is accommodated in a package, what is called a CAN-package-type laser device. The light exiting surface of a package 202 is provided with a collimator lens 203, which is formed of a convex lens, and the blue light BL1 parallelized by the collimator lens 203 is outputted. The light sources 201 may instead each be a light emitter having a configuration in which a plurality of semiconductor laser chips are accommodated in a single package.

The afocal system 35 is provided between the light source apparatus 20 and the light separator 21. The afocal system 35 reduces the luminous flux diameter of the blue light BL outputted from the light source apparatus 20. The afocal system 35 is formed of a convex lens 351 having positive power and a concave lens 352 having negative power. In the present embodiment, the afocal system 35 is formed of one convex lens and one concave lens, but the number of lenses that form the afocal system 35 is not limited to a specific number.

The light separator 21 is so disposed as to incline by 45° with respect to the optical axes ax1 and ax2. That is, the light separator 21 is provided in the position where the optical axis ax1 of the light source apparatus 20 and the optical axis ax2 of the wavelength converter 23 intersect with each other. The light separator 21 is characterized so as to reflect light that belongs to a blue wavelength band and transmit light that belongs to a yellow wavelength band. The light separator 21 therefore reflects the blue light BL outputted from the light source apparatus 20 and transmits the fluorescence YL emitted from the wavelength converter 23.

The light separator 21 includes a light transmissive substrate 211 and a dichroic mirror 212. The dichroic mirror 212 is provided at the light transmissive substrate 211, reflects the blue light BL outputted from the light source apparatus 20, and transmits the fluorescence YL emitted from the wavelength converter 23. The dichroic mirror 212 is provided at part of the region of the light transmissive substrate 211 in the present embodiment, but the size of the light transmissive substrate 211 may instead be reduced to the size of the dichroic mirror 212, and the dichroic mirror 212 may be provided across the entire region of the light transmissive substrate 211.

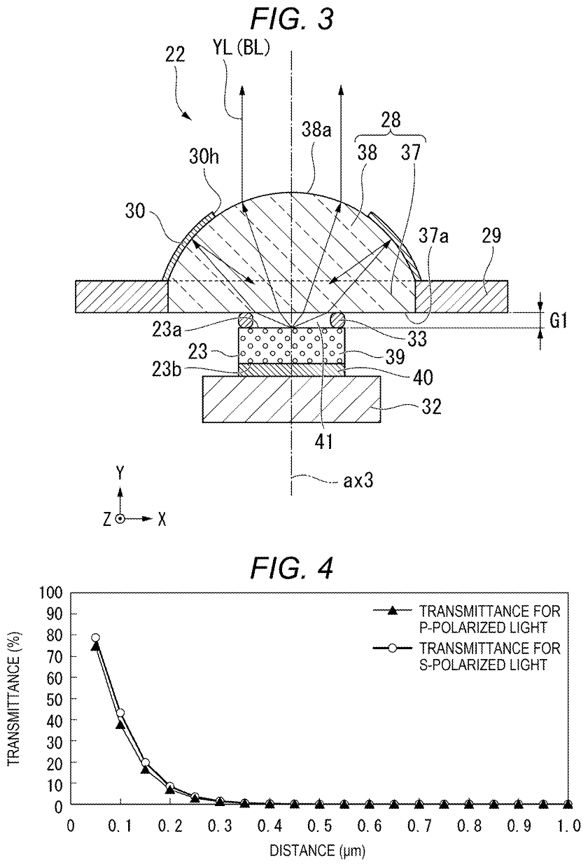

FIG. 3 is a cross-sectional view of the wavelength conversion apparatus 22.

The wavelength conversion apparatus 22 includes the wavelength converter 23, the optical element 28, a first heat dissipating member 29, a reflection mirror 30, a second heat dissipating member 32, and a spacer 33, as shown in FIG. 3.

The wavelength converter 23 converts the blue light BL having exited out of the optical element 28 into the fluorescence YL, which belongs to a second wavelength band different from the first wavelength band. The wavelength converter 23 contains a ceramic phosphor that converts the blue light BL into the yellow fluorescence YL. The second wavelength band ranges, for example, from 490 to 750 nm, and the fluorescence YL is yellow light containing the green light component and the red light component. The phosphor may contain a monocrystalline phosphor. The wavelength converter 23 has a substantially square planar shape when viewed in the direction in which the blue light BL is incident (axis-Y direction). The wavelength converter 23 has a first surface 23a, which faces the optical element 28, and a second surface 23b opposite from the first surface 23a. The fluorescence YL in the present embodiment corresponds to the second light in the claims.

Specifically, the wavelength converter 23 contains, for example, an yttrium-aluminum-garnet-based (YAG-based) phosphor. Consider YAG:Ce, which contains cerium (Ce) as an activator, by way of example, and the YAG:Ce phosphor can be made, for example, of a material produced by mixing raw powder materials containing Y₂O₃, Al₂O₃, CeO₃, and other constituent elements with one another and causes the mixture to undergo a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method. The cerium (Ce) content ranges from about 0.1 to 1 mol % vol. The wavelength converter 23 having the cerium content described above can efficiently generate yellow fluorescence.

The wavelength converter 23 contains a scattering element that scatters the blue light BL and the fluorescence YL. The scattering element is a plurality of pores 39 formed in the phosphor. It is effective that the size of the pores 39 is equal to or smaller than the wavelength of the fluorescence YL, because the fluorescence YL is not absorbed when the fluorescence YL is reflected at the interface between the pores 39 and the fluorophore. In particular, the size of the pores 39 may be greater than or equal to 1/10 the wavelength of the fluorescence YL but smaller than or equal thereto, desirably about ¼ the wavelength. The scattering caused by the scattering element is Mie scattering. The plurality of pores 39 can be created, for example, by lowering the sintering temperature used when the material of wavelength converter 23 is sintered and stopping the sintering process halfway through, or by mixing a pore forming resin with the material of wavelength converter 23 and sintering the mixture. The fluorescence YL generated in the phosphor is scattered by the pores 39 and emitted out of the wavelength converter 23. Out of the blue light BL having entered the wavelength converter 23, part of the blue light BL is converted in terms of wavelength into the fluorescence YL, whereas the other part of the blue light BL is backscattered by the pores 39 and caused to exit out of the wavelength converter 23 without undergoing the wavelength conversion.

The optical element 28 is provided between the light separator 21 and the wavelength converter 23. The optical element 28 includes a planar plate part 37 and a lens part 38. The lens part 38 is formed at one surface of the planar plate part 37 integrally therewith. The optical element 28 is so configured that the lens part 38 faces the light separator 21 and the planar plate part 37 faces the wavelength converter 23. The planar plate part 37 has a third surface 37a, via which the blue light BL exits and on which the fluorescence YL and the blue light BL are incident. The lens part 38 has a hemispherical surface 38a, on which the blue light BL is incident and via which the fluorescence YL and the blue light BL exit, and has positive power. The center of the hemispherical surface 38a is located on the first surface 23a of the wavelength converter 23. The lens part 38 focuses the blue light BL that exits out of the light separator 21 and causes the focused blue light BL to enter the wavelength converter 23. Furthermore, the lens part 38 converts the angular distribution of the fluorescence YL and the blue light BL that exit out of the wavelength converter 23 and causes the resultant light to exit. The center axis of the hemisphere that forms the shape of the lens part 38 is defined as an optical axis ax3 of the optical element 28. The center axis ax3 of the optical element 28 coincides with the optical axis ax2 of the wavelength converter 23.

The optical element 28 is made of a light transmissive material having a small coefficient of linear expansion. The YAG fluorophore in the wavelength converter 23 generates heat, and the maximum temperature at which the YAG fluorophore can maintain its light emission efficiency is approximately 200° C., so that heat is generated at temperatures lower than or equal to 200° C. When heat is generated, the temperature of the optical element 28 in the vicinity of the region, of the wavelength converter 23, that is irradiated with the blue light BL rises, so that the optical element 28 partially expands. Since the expansion of the optical element 28 occurs in the vicinity of the light irradiated region, there is a risk of damage to the optical element 28 due to internal stress induced as a result of the difference in the amount of expansion between the region in the vicinity of the light irradiated region and the region away therefrom. It is therefore desirable that the coefficient of linear expansion of the optical element 28 is small to suppress the damage to the optical element 28.

Specifically, the coefficient of linear expansion of the optical element 28 is desirably smaller than or equal to 65×10⁻⁷/° C., more desirably, smaller than or equal to 55×10⁻⁷/° C. at temperatures ranging from 100° C. to 200° C. The coefficient of linear expansion of ordinary white sheet glass is about 93×10⁻⁷/° C., which exceeds 65×10⁻⁷/° C. If the optical element is made of ordinary white plate glass, the optical element breaks in many cases. In contrast, an optical element made, for example, of H3 glass (manufactured by Okamoto Glass Co., Ltd.), one of borosilicate glass products, S-LAL 21 (manufactured by OHARA INC.), or quartz glass does not break. The coefficients of linear expansion of the glass materials described above are all smaller than or equal to 55×10⁻⁷/° C. at temperatures ranging from 100° C. to 200° C.

Instead, to suppress the heat concentration described above, the optical element 28 may be made of a material having a thermal conductivity greater than or equal to 7 W/m·K, such as magnesium oxide or any other thermally conductive transparent ceramic material, fluorite, and quartz. Even when the thermal conductivity is about 1 W/m·K, such as the thermal conductivity of Pyrex (registered trademark), however, a heat distribution effect can be achieved without thermal damage as long as the coefficient of linear expansion is smaller than or equal to 65×10⁻⁷/° C. That is, the optical element 28 only needs to be made of a material characterized in that heat distribution prevents thermal stress concentration. Furthermore, S-LAL21, magnesium oxide, and other similarly characterized materials are desirable also in that they have high refractive indices and excel in the function as a pickup lens. Calcium fluoride having a refractive index of 1.45 can also be used as the material of the optical element 28. Calcium fluoride has an advantage of being soft and readily polished, and further has a high thermal conductivity of 9 W/m·K. It is therefore more desirable that the optical element 28 is made of a material having both a low coefficient of linear expansion and high thermal conductivity, such as quartz, sapphire, fluorite, and magnesium oxide.

As described above, the optical element 28 receives the heat from the wavelength converter 23 and has the function as a heat sink as well as the function of a pickup lens. It is therefore desirable that the optical element 28 has high thermal conductivity, and that the product of the specific heat, the density, and the volume of the optical element 28 is greater than or equal to the product of the specific heat, the density, and the volume of the wavelength converter 23. The heat capacity defined by the specific heat×the density×the volume is a yardstick of the performance of a heat sink. The YAG fluorophore that forms the wavelength converter 23 has a specific heat of 600 J/kg·K, a density of 4.55, and a thickness of 50 μm. Therefore, in a 1-mm-cubic wavelength converter 23, the heat capacity is 1.36×10⁻⁹ J/K, which is a very small value. The optical element 28 therefore functions adequately as a heat sink.

For example, the glass that forms the optical element 28 has a specific heat ranging from 800 to 900 J/kg·K and has a density of about 2.5, so that the heat capacity of the glass optical element 28 is only 82% of that of the YAG fluorophore. Since the optical element 28 can be thicker than or equal to 1 mm, however, the heat capacity of the optical element 28 can be 16 times greater than or equal to the heat capacity of the wavelength converter 23. It is noted that since copper has a specific heat of 900 J/kg·K and a density of 9, the heat capacity of copper is 60 times the heat capacity of the wavelength converter 23 provided that the thickness is 1 mm. The heat capacity of glass is about 28% of that of copper, and quartz crystal and calcium fluoride crystal have substantially the same heat capacity as that of glass, so that these materials therefore form effective coolers.

Setting the volume of the optical element 28 to be 1×10⁴ times, desirably, 1×10³ times the volume of the wavelength converter 23 allows the heat capacity to increase substantially in proportion to the volume, whereby the heat generated by the wavelength converter 23 can be greatly suppressed. For example, when the optical element 28 is made of light transmissive alumina, and assuming that the volume of the optical element 28 is 1×10⁴ times the volume of the wavelength converter 23 having the dimensions of 1 mm×1 mm×50 μm, that is, the length of one side of the optical element 28 is 10 times one side of the wavelength converter 23, and the thickness of the optical element 28 is 100 times the thickness of the wavelength converter 23, so that the volume of the optical element 28 is 10 mm×10 mm×5 mm, the heat capacity of the optical element 28 is 0.015 J/K. That is, heat equivalent to 1.5 W raises the temperature of the optical element 28 by 100° C. When the volume of the optical element 28 is 1×10³ times the volume of the wavelength converter 23 having the dimensions of 1 mm×1 mm×50 μm, the heat equivalent to 15 W raises the temperature of the optical element 28 by 100° C. This level of heat sink performance of the optical element 28 is sufficient for surface cooling of the wavelength converter 23. For example, incidence of the blue light BL equivalent to 50 to 100 W generates heat equivalent to about 40 W. Therefore, 15 W in the optical element 28 is 40% of the total generated heat, and the optical element 28 serves as a sufficient auxiliary heat sink. When the heat capacity of the optical element 28 is 0.015 J/K, the cooling performance is preferably further increased.

To this end, in the present embodiment, the first heat dissipating member 29 is provided at the side surface of the optical element 28. The first heat dissipating member 29 is thermally coupled to the optical element 28. That is, the first heat dissipating member 29 may be in direct contact with the optical element 28 or may be coupled therewith via any heat transfer member. The first heat dissipating member 29 is made of a material having relatively high density, for example, copper, aluminum, iron, and alumina. The performance of the first heat dissipating member 29 as a heat sink is thus improved, whereby the performance of cooling the wavelength converter 23 can be further increased. The first heat dissipating member 29 in the present embodiment corresponds to the heat dissipating member in the claims.

The reflection mirror 30 is provided at a circumferential edge portion, of the hemispherical surface 38a of the lens part 38, that is far from the optical axis ax3. In other words, the reflection mirror 30 has a circular opening 30h around the optical axis ax3. The reflection mirror 30 is formed of a dielectric multilayer film formed at the lens part 38. Specifically, the opening 30h having an opening angle of 74° is set in the vicinity of the apex of the hemispherical surface 38a, and the dielectric multilayer film is formed around the opening 30h. Even when the fluorescence YL or the blue light BL that passes through the opening 30h becomes a slightly divergent beam, a downstream parallelizing lens can, for example, added to produce a beam with the divergence suppressed. On the other hand, the fluorescence YL or the blue light BL that has not passed through the opening 30h but has been reflected off the reflection mirror 30 traces back the path and enters the wavelength converter 23. When the opening angle of the opening 30h is 74°, the reflection mirror 30 is designed to reflect the fluorescence YL by the amount equal to half the light intensity thereof to the wavelength converter 23.

The second heat dissipating member 32 is provided at the second surface 23b of the wavelength converter 23 via a bonding layer 40. In detail, the second surface 23b of the wavelength converter 23 is so polished that surface roughness Ra is smaller than or equal to 10 nm, a reflection coating formed of a dielectric multilayer film is provided at the second surface 23b, and a low-refractive-index layer made of air-containing nano-silica and having a refractive index of smaller than or equal to 1.3 is provided at the reflection coating. The order in accordance with which the dielectric multilayer and the low-refractive-index layer are layered on each other may be reversed. When the low-refractive-index layer is provided at the second surface 23b, the low-refractive-index layer can fill recesses formed on the second surface 23b by the plurality of pores 39, so that the reflection performance of the dielectric multilayer film is readily achieved. The bonding layer 40 is made, for example, of solder. The second heat dissipating member 32 is made of metal, for example, copper. Part of the heat generated by the wavelength converter 23 is dissipated out thereof by the second heat dissipation member 32 via the second surface 23b. As described above, the wavelength converter 23 has a reflection layer disposed at the second surface 23b of the wavelength converter 23 and formed, for example, of a dielectric multilayer film, and the reflection layer reflects the blue light BL and the fluorescence YL toward the optical element 28.

The spacer 33 is provided between the wavelength converter 23 and the optical element 28. The spacer 33 maintains the distance between the wavelength converter 23 and the optical element 28. The shape of the spacer 33 is not limited to a specific shape, and the number of spacers 33 is not limited to a specific number. The wavelength converter 23 and the optical element 28 are thus separate from each other, and an air layer 41 is provided between the wavelength converter 23 and the optical element 28. The air layer 41 has a length G1 along the direction of the optical axis ax3 of the optical element 28 and greater than or equal to 0.3 μm but smaller than or equal to 9.0 μm. The rationale for the reason why the length G1 of the air layer 41 along the direction of the optical axis ax3 of the optical element 28 is set so as to fall within the range described above will be described later.

Specifically, the spacer 33 having a height greater than or equal to 0.3 μm but smaller than or equal to 9.0 μm is formed at a circumferential edge portion of the first surface 23a of the wavelength converter 23. The spacer 33 is formed, for example, by printing silicone resin containing a gap agent having a diameter greater than or equal to 0.3 μm but smaller than or equal to 9.0 μm on either the wavelength converter 23 or the optical element 28 and by sintering the resultant structure. Instead, glass is printed on the circumferential edge portion of the first surface 23a of the wavelength converter 23 to a thickness greater than or equal to 0.3 μm but smaller than or equal to 9.0 μm, bonding the wavelength converter 23 and the optical element 28 to each other, and sintering the resultant structure. An air gap having the thickness ranging from 0.3 μm to 9.0 μm is thus formed between the wavelength converter 23 and the optical element 28. In this state, the wavelength converter 23 and the optical element 28 are fixed to each other. For example, the wavelength converter 23 and the optical element 28 may be bonded to each other with an adhesive made of resin or any other material, or may be mechanically fixed to each other with a spring or any other elastic member.

As will be described later, the distance between wavelength converter 23 and the optical element 28, that is, the length G1 of the air layer 41 ranges from somewhere around the wavelength to several tens of times the wavelength, and the wavelength converter 23 and the optical element 28 are disposed sufficiently close to each other. The fluorescence YL emitted from the wavelength converter 23 is emitted in the form of light having the Lambertian distribution. Since the wavelength converter 23 is in close proximity to the optical element 28, however, the fluorescence YL incident on the optical element 28 at large angles of incidence travels back and forth between the optical element 28 and the wavelength converter 23, and repeatedly enters the wavelength converter 23 and is scattered therein. The fluorescence YL thus enters the optical element 28 during the travel along the short distance.

For example, the distance required for a beam incident on the optical element 28 at an angle of incidence of 86° to be reflected 6 times off the optical element 28 within a distance of 1 μm is 6×tan 86°×1 μm=86 μm, which causes the fluorescence YL to diverge by an acceptable amount. That is, the fluorescence YL enters the optical element 28 or the wavelength converter 23 while traveling over the distance of 86 μm. The wavelength converter 23 contains the pores 39 having the size ranging from about 0.1 μm to 1 μm and being present in a volume of 2 μm×2×2 μm at a count of about 1 or 2, so that the fluorescence YL having entered the wavelength converter 23 is scattered by the pores 39 and outputted from the wavelength converter 23 and enters the optical element 28. The fluorescence YL emitted from the wavelength converter 23 is thus hardly lost but enters the optical element 28.

In the present embodiment, since the afocal system 35 is provided between the light source apparatus 20 and the light separator 21, the blue light BL is incident on the dichroic mirror 212 with the luminous flux diameter of the blue light BL reduced, as shown in FIG. 2. The size of the dichroic mirror 212 can therefore be reduced as compared with a case where no afocal system 35 is provided. In addition, the concave lens 352 of the afocal system 35 can reduce aberrations associated with the blue light BL focused on the wavelength converter 23. Since the dichroic mirror 212 is characterized so as to transmit the yellow light component, a central luminous flux of the fluorescence YL emitted from the wavelength converter 23 passes through the optical element 28 and then passes through the dichroic mirror 212. The peripheral luminous flux of the fluorescence YL emitted from the wavelength converter 23 is not incident on the dichroic mirror 212 but passes through the light transmissive substrate 211 or the space outside the light separator 21.

Out of the blue light BL having exited out of the wavelength converter 23, a central luminous flux is incident on the dichroic mirror 212, but the peripheral luminous flux is not incident on the dichroic mirror 212 but passes through the light transmissive substrate 211 or the space outside the light separator 21. A central luminous flux of the blue light BL incident on the dichroic mirror 212 is reflected off the dichroic mirror 212 and lost. On the other hand, the blue light BL that is not incident on the dichroic mirror 212 is used as illumination light WL along with the fluorescence YL. In this case, reducing the size of the dichroic mirror 212 can reduce the amount of blue light BL reflected off the dichroic mirror 212 and lost.

The blue light BL and the fluorescence YL thus enter the optical integration system 24. The blue light BL and the yellow fluorescence YL are combined with each other into the illumination light WL, which is white light.

The optical integration system 24 includes a first multi-lens array 241 and a second multi-lens array 242. The first multi-lens array 241 includes a plurality of first lenses 2411, which divide the illumination light WL into a plurality of sub-luminous fluxes.

The lens surface of the first multi-lens array 241, that is, the surfaces of the first lenses 2411 are conjugate with the image formation region of each of the light modulators 4R, 4G, and 4B. Therefore, when viewed in the direction of the optical axis ax2, the first lenses 2411 each have a rectangular shape substantially similar to the shape of the image formation region of each of the light modulators 4R, 4G, and 4B. The sub-luminous fluxes having exited out of the first multi-lens array 241 are thus each efficiently incident on the image formation region of each of the light modulators 4R, 4G, and 4B.

The second multi-lens array 242 includes a plurality of second lenses 2421 corresponding to the plurality of first lenses 2411 of the first multi-lens array 241. The second multi-lens array 242 along with the superimposing lens 26 brings images of the first lenses 2411 of the first multi-lens array 241 into focus in the vicinity of the image formation region of each of the light modulators 4R, 4G, and 4B.

The illumination light WL having passed through the optical integration system 24 enters the polarization converter 25. The polarization converter 25 has a configuration in which polarization separation films and retardation films that are not shown are arranged in an array. The polarization converter 25 aligns the polarization directions of the illumination light WL with a predetermined direction. Specifically, the polarization converter 25 aligns the polarization directions of the illumination light WL with the direction of the transmission axis of the light-incident-side polarizers for the light modulators 4R, 4G, and 4B.

The polarization directions of the red light LR, the green light LG, and the blue light LB separated from the illumination light WL having passed through the polarization converter 25 coincide with the transmission axis direction of the light-incident-side polarizers for the light modulators 4R, 4G, and 4B. The red light LR, the green light LG, and the blue light LB are therefore incident on the image formation regions of the light modulators 4R, 4G, and 4B, respectively, without being blocked by the light-incident-side polarizers.

The illumination light WL having passed through the polarization converter 25 enters the superimposing lens 26. The superimposing lens 26, in cooperation with the optical integration system 24, homogenizes the illuminance distribution in the image formation region of each of the light modulators 4R, 4G, and 4B, which are illumination receiving regions.

### Comparable Examples

Wavelength conversion apparatuses according to Comparative Examples will be descried below.

FIG. 6 is a schematic configuration diagram of a wavelength conversion apparatus 200 according to Comparative Example 1.

The wavelength conversion apparatus 200 according to Comparative Example 1 includes a wavelength converter 223 and a pickup lens 224, as shown in FIG. 6. The wavelength converter 223 and the pickup lens 224 are disposed via an air layer 225. A distance G2 between the wavelength converter 223 and the pickup lens 224 is, for example, 0.5 mm. When the distance G2 between the wavelength converter 223 and the pickup lens 224 is large as described above, heat generated, if any, by the wavelength converter 223 does not cause a risk of damage to the pickup lens 224 because the heat transferred from the wavelength converter 223 to the pickup lens 224 is small.

The wavelength conversion apparatus 200 according to Comparative Example 1, however, has the following problems.

For example, consider a case where the pickup lens 224 has a refractive index of 1.4. Out of the fluorescence YL emitted from the wavelength converter 223, fluorescence YL1 incident on a light incident surface 224a of the pickup lens 224 at angles of incidence smaller than 45° is refracted at the light incident surface 224a, enters the pickup lens 224, and exits out of the pickup lens 224 in the form of the fluorescence YL1 having a luminous flux diameter W2. In contrast, fluorescence YL2 incident on the light incident surface 224a at angles of incidence greater than or equal to 45° is reflected off the light incident surface 224a and cannot enter the pickup lens 224.

When a wavelength converter containing a scattering element such as pores is excited, the fluorescence from the wavelength converter is emitted in the Lambertian scheme according to the cosine law. Therefore, in the wavelength conversion apparatus 200 according to Comparative Example 1, out of the fluorescence emitted from the wavelength converter 223, about 4% of the fluorescence YL2 is reflected off the light incident surface 224a of the pickup lens 224, undergoes reflection between the wavelength converter 223 and the pickup lens 224, and leaks out of the wavelength conversion apparatus 200. In detail, most of the S-polarized light incident on the light incident surface 224a of the pickup lens 224 at angles of incidence greater than or equal to 75° leaks out of the wavelength converter apparatus 200. The loss corresponds to 4% of the fluorescence emitted from wavelength converter 223.

Furthermore, when an optical system that causes part of the fluorescence in the pickup lens to return to the wavelength converter via a reflection mirror to narrow the luminous flux diameter of the light that exits out of the pickup lens, what is called a recycling optical system is employed, the fluorescence YL2 having returned to the wavelength converter 223 is scattered by the internal pores, causing Lambert reflection. In this case, the behavior of the fluorescence YL2 follows the cosine law as the behavior of the emitted fluorescence YL2 does, so that 4% of the fluorescence YL2 that enters the pickup lens 224 is reflected off the surface of the air gap between the wavelength converter 223 and the pickup lens 224 and lost. The phenomenon is repeated in the recycling optical system, so that the 4% loss described above accumulates, resulting in a large amount of loss of the fluorescence. For example, when 50% of the fluorescence is recycled and 4% of the recycled fluorescence is lost, the total loss is 4+2+1+0.5+ . . . =8%, which is a large amount of loss. The recycling thus at least doubles even a small loss, so that it is difficult to employ a recycling optical system.

FIG. 7 is a schematic configuration diagram of a wavelength conversion apparatus 300 according to Comparative Example 2.

The wavelength conversion apparatus 300 according to Comparative Example 2 includes a wavelength converter 323 and a pickup lens 324, as shown in FIG. 7. The wavelength converter 323 and the pickup lens 324 are disposed so as to be in contact with each other. That is, no air layer is present between the wavelength converter 323 and the pickup lens 324. According to the configuration described above, there is no loss of the fluorescence caused by the gap between the wavelength converter and the pickup lens, unlike in Comparative Example 1.

When the pickup lens 324 is in contact with the wavelength converter 323, however, no refraction occurs at a light incident surface 324a of the pickup lens 324, and fluorescence YL3 travels through the interior of the pickup lens 324 with the Lambertian distribution maintained. As a result, a luminous flux diameter W3 of the fluorescence YL3 that exits out of the pickup lens 324 is greater than the luminous flux diameter W2 in Comparison Example 1. Therefore, in Comparative Example 2, the etendue of the wavelength conversion apparatus 300 is greater than that in Comparative Example 1, so that the light utilization efficiency in a downstream optical system decreases.

The present inventor therefore considered that providing the very thin air layer 41 between the optical element 28, which functions as a pickup lens, and the wavelength converter 23 could solve the problems with the wavelength conversion apparatuses according to Comparative Examples 1 and 2. The present inventor conducted a simulation for determining the minimum distance between the wavelength converter 23 and the optical element 28 (length G1 of air layer 41).

As the simulation, consider a situation in which the fluorescence YL emitted from wavelength converter 23 passes through the air layer 41 and reaches the third surface 37a of the optical element 28 at a specific angle of incidence, and the amount of the fluorescence YL incident on the third surface 37a at the specific angle of incidence, passing therethrough, and entering the optical element 28 is calculated. The simulation was conducted under the following conditions: The refractive index of the wavelength converter 23 was 1.8; the refractive index of the optical element 28 was 1.8; the refractive index of the air layer 41 was 1.0; and the distance between the wavelength converter 23 and the optical element 28 (length G1 of air layer 41) was varied. The calculation was also performed under the condition of using two different angles of incidence, 45° and 35°. The angle of incidence of 45° is the angle at which the fluorescence YL is totally reflected off the third surface 37a of the optical element 28, and the angle of incidence of 35° is the critical angle at which the fluorescence YL is totally reflected off the third surface 37a of the optical element 28.

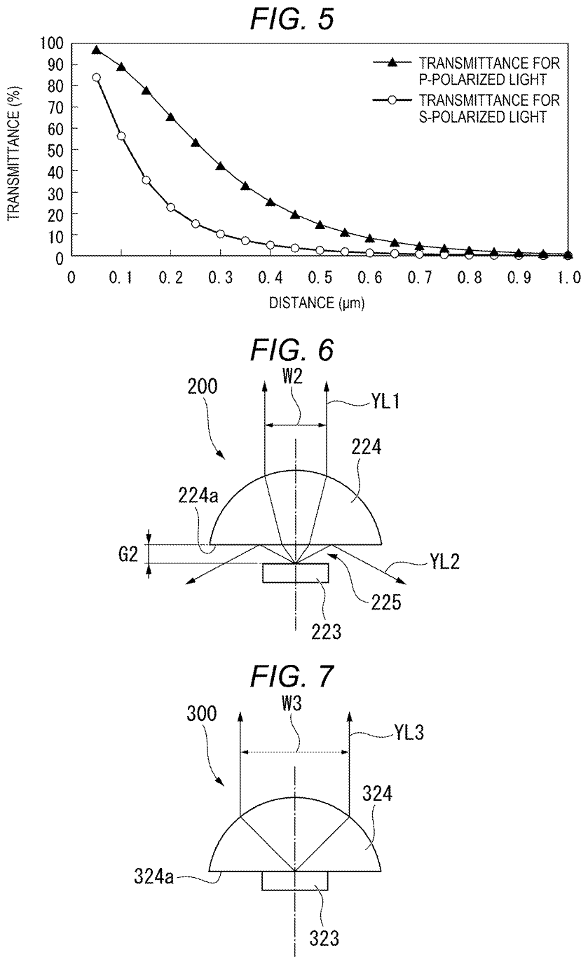

FIG. 4 shows graphs illustrating the relationship of the distance between the wavelength converter 23 and the optical element 28 with the transmittance of the third surface 37a of the optical element 28 in the case where the angle of incidence is 45°. FIG. 5 shows graphs illustrating the relationship of the distance between the wavelength converter 23 and the optical element 28 with the transmittance of the third surface 37a of the optical element 28 in the case where the angle of incidence is 35°. In FIGS. 4 and 5, the horizontal axis represents the distance (μm) between the wavelength converter 23 and the optical element 28. The vertical axis represents the transmittance (%). The transmittance in FIGS. 4 and 5 is defined as follows: Provided that the total amount of fluorescence YL incident on the third surface 37a of the optical element 28 at the angle of incidence of 45° or 35° is 100%, the transmittance is the proportion of the fluorescence having passed through the third surface 37a and entered the optical element 28.

When fluorescence YL enters the air layer 41 from the wavelength converter 23, and when the fluorescence YL passes through the air layer 41 as an evanescent wave and enters the optical element 28, the transmittance increases even though the angle of incidence causes total reflection because no total reflection occurs, as shown in FIGS. 4 and 5. That is, in the region where the distance (length G1 of air layer 41) is sufficiently small, the fluorescence YL does not recognize the air layer 41, so that the fluorescence YL passes through the interface between the air layer 41 and the optical element 28 without being refracted at the interface. In contrast, in the region where the distance (length G1 of air layer 41) is large, the fluorescence YL recognizes the air layer 41, so that the fluorescence YL is totally reflected off the interface between the air layer 41 and the optical element 28. That is, in the region where the length G1 of the air layer 41 is large, Snell's law of refraction holds. In this case, the luminous flux diameter of the fluorescence YL passing through the interface between the air layer 41 and the optical element 28 can be reduced, as described in the paragraph relating to Comparative Example 1. The refraction of the fluorescence at the interface between the air layer 41 and the optical element 28 allows reduction in the etendue, which is useful for a focusing optical system of a projector or any other similar apparatus.

The results of the simulation show that when the distance between the wavelength converter 23 and the optical element 28 is very small, the fluorescence YL emitted from the wavelength converter 23 passes through the air layer 41 without being refracted as an evanescent wave. Specifically, when the angle of incidence is 45°, the transmittance at which the air layer 41 transmits both the P-polarized light and S-polarized light of the fluorescence YL increases in the region where the distance between the wavelength converter 23 and the optical element 28 is smaller than 0.3 μm, as shown in FIG. 4. In this case, the fluorescence YL emitted from wavelength converter 23 is not refracted at the interface between the air layer 41 and the optical element 28 but travels straight and becomes a more divergent beam after exiting out of the optical element 28, so that part of the fluorescence YL cannot enter a downstream optical system. In the case of the angle of incidence of 45°, when the distance between the wavelength converter 23 and the optical element 28 is greater than or equal to 0.3 μm, the fluorescence YL is refracted at the interface between the air layer 41 and the optical element 28 and enters the optical element 28.

When the angle of incidence is 35°, and when the distance between the wavelength converter 23 and the optical element 28 is greater than or equal to 0.9 μm, the fluorescent YL is refracted at the interface between the air layer 41 and the optical element 28 and enters the optical element 28 regardless of whether the fluorescent YL is P-polarized or S-polarized although the P polarized light and the S polarized light slightly differ from each other in terms of behavior, as shown in FIG. 5. Based on the results described above, when the distance between the wavelength converter 23 and the optical element 28 is greater than or equal to 0.3 μm, desirably, greater than or equal to 0.9 μm, the fluorescence YL emitted from the wavelength converter 23 is refracted at the interface between the air layer 41 and the optical element 28 (third surface 37a of optical element 28) and enters the optical element 28.

The present inventor then studied the maximum distance between the wavelength converter 23 and the optical element 28 (length G1 of air layer 41).

A simulation shows that the reflectance at which the wavelength converter 23 or the optical element 28 reflects the fluorescence YL exceeds 80% when the angle of incidence is 86°. On the other hand, since the fluorescence YL is emitted from the wavelength converter 23 in the Lambertian scheme, the proportion of the emitted luminous flux with respect to the total luminous flux becomes 0.18% when the angle of emission is 83° provided that the emission follows the cosine law. The amount of fluorescence YL over the range from the angle of incidence of 83° to the angle of incidence of 86° is 0.15%, so that the calculation is performed by assuming that most of the reflected fluorescence YL incident at angles of incidence smaller than or equal to 83° is incident at angles of incidence greater than or equal to 86°.

Provided that the amount of fluorescent YL incident on the third surface 37a of the optical element 28 over the range from the angle of incidence of 83° to the angle of incidence of 86° is 100%, the amount of fluorescent YL reflected off the third surface 37a and incident on the first surface 23a of the wavelength converter 23 is smaller than or equal to 80%. On the other hand, the amount of fluorescence YL that enters the wavelength converter 23 is greater than or equal to 20%. The amount of fluorescence YL that enters the wavelength converter 23 is therefore 80%×20%=16%. Similarly, the amount of fluorescence YL reflected again off the optical element 28 and then reflected off the first surface 23a of the wavelength converter 23 is smaller than or equal to 80%×80%×80%×80%=41%. The amount of component that remains as specularly reflected light is smaller than or equal to 0.2%×41%=0.08%. That is, when the fluorescence YL is reflected twice off the first surface 23a of the wavelength converter 23, 59% of the amount of fluorescence YL enters the wavelength converter 23. The amount of fluorescence YL entering the wavelength converter 23 is a small value smaller than or equal to 0.08% of the total amount of emitted fluorescence YL.

The fluorescence YL having entered the wavelength converter 23 is scattered by the pores 39 in the wavelength converter 23 and is emitted again as Lambertian diffused light from the wavelength converter 23. Most of the fluorescence YL therefore enters the optical element 28. That is, when the specularly reflected light incident at the angle of incidence of 83° reaches twice the first surface 23a of the wavelength converter 23, 0.08% of the fluorescence YL becomes the specularly reflected light, and the other fluorescence YL enters the optical element 28. The fluorescence YL that is lost as the specularly reflected light traveling sideways from the gap between the wavelength converter 23 and the optical element 28 is negligible.

Provided that the blue light BL at the first surface 23a of the wavelength converter 23 has a 1-mm square size, and allowable divergence of the fluorescence YL is 0.1 mm, the allowable value of 0.1 mm is achieved after four times of specular reflection at the angle of incidence of 86° with the distance between the wavelength converter 23 and the optical element 28 being 2 μm. Provided that the allowable divergence of the fluorescence YL is 0.25 mm, which is one-fourth the size of the blue light BL, the allowable value of 0.25 mm is achieved after four times of specular reflection at the angle of incidence of 86° with the distance between the wavelength converter 23 and the optical element 28 being 4 μm. Provided that the allowable divergence of the fluorescence YL is 0.5 mm, which is half the size of the blue light BL, the allowable value of 0.5 mm is achieved after four times of specular reflection at the angle of incidence of 86° with the distance between the wavelength converter 23 and the optical element 28 being 9 μm. As described above, it is desirable that the distance between the wavelength converter 23 and the optical element 28 is smaller than or equal to 9 μm, more desirably, smaller than or equal to 4 μm, and still more desirably, smaller than or equal to 2 μm.

The distance between the wavelength converter 23 and the optical element 28 will next be examined from the viewpoint of thermal conductivity.

Since the thermal conductivity of air is about 0.03 W/m·K, in order for the heat capacity of the air layer 41 to be comparable to that of the wavelength converter 23 having a thickness of 50 μm, the thickness of the air layer 41 is 0.03/(7/50 μm)=0.2 μm, provided that the thermal conductivity of the YAG phosphor that constitutes the wavelength converter 23 is 7 W/m·K. Therefore, from a thermal point of view, the distance between the wavelength converter 23 and the optical element 28 is desirably about 0.2 μm. When the distance between the wavelength converter 23 and the optical element 28 is 0.3 μm, a little less than half the heat generated by the wavelength converter 23 can be dissipated from the optical element 28. When the distance between the wavelength converter 23 and the optical element 28 is 1 μm, 16% of the amount of heat generated by the wavelength converter 23 is dissipated, and when the distance between the wavelength converter 23 and the optical element 28 is 2 μm, 8% of the amount of heat generated by the wavelength converter 23 is dissipated. The blue light BL corresponding to 8% and 16% of the generated heat is allowed to enter the optical element 28, whereby the amount of light emitted from the wavelength converter 23 can be increased.

### Effects of First Embodiment

The illuminator 2 according to the present embodiment includes the light source apparatus 20, which outputs the blue light BL, which belongs to the first wavelength band, the wavelength converter 23, which converts the blue light BL into the fluorescence YL, which belongs to the second wavelength band different from the first wavelength band, and the optical element 28, which transmits the fluorescence YL emitted from the wavelength converter 23. The air layer 41 is provided between the wavelength converter 23 and the optical element 28, and has the length G1 along the direction of the optical axis ax3 of the optical element 28 and greater than or equal to 0.3 μm but smaller than or equal to 9.0 μm. The optical element 28 has a coefficient of linear expansion smaller than or equal to 65×10⁻⁷/° C. at temperatures ranging from 100° C. to 200° C., and a thermal conductivity greater than or equal to 1.0 W/m·K.

According to the configuration described above, since the length G1 of the air layer 41 along the direction of the optical axis ax3 of the optical element 28 is greater than or equal to 0.3 μm but smaller than or equal to 9.0 μm, the amount of fluorescence YL leaking sideways from the gap between the wavelength converter 23 and the optical element 28 can be reduced, and the divergence of the fluorescence YL due to the multiple-time reflection between the wavelength converter 23 and the optical element 28 can be suppressed to a small amount. Since the fluorescence YL traveling from the wavelength converter 23 to the optical element 28 recognizes the air layer 41, the fluorescence YL is refracted by the air layer 41, and exits out of the optical element 28 with the luminous flux diameter of the fluorescence YL reduced. The illuminator 2 achieved by the present embodiment can therefore output light used by a downstream optical system at high light utilization efficiency. Furthermore, since the coefficient of linear expansion of the optical element 28 is smaller than or equal to 65×10⁻⁷/° C. at temperatures ranging from 100° C. to 200° C., and the thermal conductivity of the optical element 28 is greater than or equal to 1.0 W/m·K, there is little risk of damage to the optical element 28, and the heat from the wavelength converter 23 can be transferred and dissipated out of the illuminator 2. Therefore, a rise in the temperature of the wavelength converter 23 can be suppressed, whereby a decrease in the wavelength conversion efficiency can be suppressed.

The illuminator 2 according to the present embodiment further includes the spacer 33, which maintains the distance between the wavelength converter 23 and the optical element 28.

According to the configuration described above, using an appropriately sized spacer 33 allows reliable control of the distance between the wavelength converter 23 and the optical element 28, that is, the length G1 of the air layer 41 between the wavelength converter 23 and the optical element 28.

The illuminator 2 according to the present embodiment further includes the first heat dissipating member 29, which is thermally coupled to the optical element 28.

According to the configuration described above, the heat transferred from the wavelength converter 23 to the optical element 28 can be further transferred to the first heat dissipating member 29. The dissipation of the heat from the wavelength converter 23 can thus be further facilitated, whereby the wavelength conversion efficiency can be sufficiently maintained.

In the illuminator 2 according to the present embodiment, the optical element 28 includes the planar plate part 37 and the lens part 38.

According to the configuration described above, the planar plate part 37 contributes to the heat dissipation from the wavelength converter 23, and the lens part 38 can contribute as a pickup lens that guides the light from the wavelength converter 23 to a downstream optical system.

The illuminator 2 according to the present embodiment further includes the reflection mirror 30, which is provided at a portion of the lens part 38 and reflects the fluorescence YL emitted from the wavelength converter 23 toward the wavelength converter 23.

According to the configuration described above, the fluorescence YL exits through the opening 30h of the reflection mirror 30, so that the luminous flux diameter of the fluorescence YL having exited out of the optical element 28 is reduced, whereby the etendue can be reduced. The fluorescence YL reflected off the reflection mirror 30 returns to the wavelength converter 23, is scattered by the pores 39, and is then emitted again from the wavelength converter 23. Since the fluorescence YL reflected off the reflection mirror 30 is thus recycled, the illuminator 2 achieved by the present embodiment can output light that allows high light utilization efficiency.

The projector 1 according to the present embodiment, which includes the illuminator 2 according to the present embodiment, excels in the light utilization efficiency.

### Second Embodiment

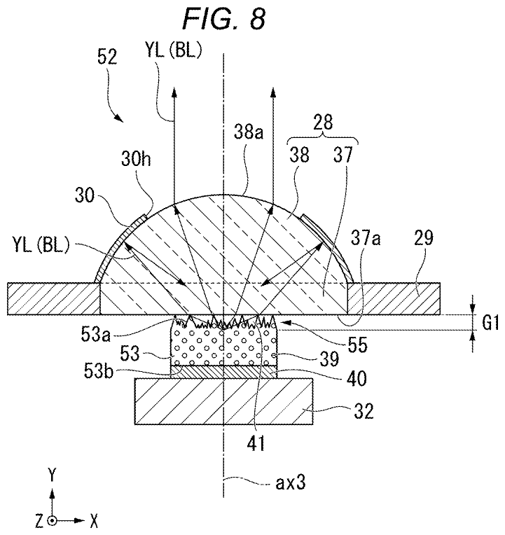

A second embodiment of the present disclosure will be described below with reference to FIG. 8.

The basic configurations of the projector and the illuminator according to the second embodiment are the same as those in the first embodiment, but differ therefrom in terms of how to ensure the distance between the wavelength converter and the optical element. The basic configurations of the projector and the illuminator will therefore not be described.

FIG. 8 is a schematic configuration diagram of a wavelength conversion apparatus 52 according to the second embodiment.

In FIG. 8, components common to those in the figures used in the first embodiment have the same reference characters and will not be described.

The wavelength conversion apparatus 52 in the present embodiment includes a wavelength converter 53, the optical element 28, the first heat dissipating member 29, the reflection mirror 30, and the second heat dissipating member 32, as shown in FIG. 8. Unlike the wavelength conversion apparatus 22 in the first embodiment, the wavelength conversion apparatus 52 in the present embodiment does not include the spacer 33.

In the present embodiment, out of the two surfaces of the wavelength converter 53, a first surface 53a and a second surface 53b, the first surface 53a facing the optical element 28 has irregularities 55. Protrusions and recesses that form the irregularities 55 have random heights arranged in random intervals. The surface roughness Ra of the first surface 53a is greater than or equal to 0.05 μm but smaller than or equal to 0.2 μm. The surface roughness Ra is the average of the heights of the plurality of protrusions and the depths of the plurality of recesses, and the maximum height of the plurality of protrusions and the maximum depth of the plurality of recesses are typically about five times the surface roughness Ra.

The distance between the wavelength converter 53 and the optical element 28, that is, the length G1 of the air layer 41 along the direction of the optical axis ax3 of the optical element 28 is determined by the protrusion having the maximum height out of the irregularities 55 of the first surface 53a of the wavelength converter 53. Therefore, adjusting the surface roughness Ra of the first surface 53a to a value greater than or equal to 0.05 μm but smaller than or equal to 0.2 μm allows the length G1 of the air layer 41 along the direction of the optical axis ax3 of the optical element 28 to be a value ranging from 0.3 μm to 1.0 μm, which corresponds to 5 times the surface roughness Ra of the first surface 53a. The other configurations of the illuminator are the same as those in the first embodiment.

### Effects of Second Embodiment

The present embodiment also provides the same effects as those provided by the first embodiment, for example, the illuminator 2 achieved by the present embodiment can suppresses damage to the optical element 28 due to heat, have high wavelength conversion efficiency, and output light that allows high light utilization efficiency.

In the illuminator 2 according to the present embodiment, the first surface 53a, of the wavelength converter 53, which faces the optical element 28 has the irregularities 55. The surface roughness Ra of the first surface 53a is greater than or equal to 0.05 μm but smaller than or equal to 0.2 μm.

According to the configuration described above, the distance between the wavelength converter 53 and the optical element 28 can be controlled to a desired value without use of a spacer.

The technical scope of the present disclosure is not limited to the embodiments described above, and a variety of changes can be made thereto to the extent that the changes do not depart from the intent of the present disclosure. An aspect of the present disclosure can be an appropriate combination of the characteristic portions in the embodiments described above. For example, an illuminator according to an aspect of the present disclosure may include the spacer in the first embodiment and the irregularities of the wavelength converter in the second embodiment.

For example, in the illuminator according to the embodiments described above, the planar plate part and the lens part of the optical element are integrated with each other into a single unit, and the planar plate part and the lens part may instead be separate parts. For example, when the planar plate part is made of a glass or ceramic material, the planar plate part has a refractive index greater than or equal to 1.4. In this case, the fluorescence from the air layer enters the optical element at an angle of incidence smaller than or equal to 45°. That is, the planar plate part and the lens part can be formed of separate members, and the planar plate part can be made of a material having high thermal conductivity. For example, the planar plate part has a thickness of 2 mm and is made of sapphire, quartz, calcium fluoride, or any other suitable material, and the lens part is made of high-refractive-index, low-dispersion glass. The planar plate part and the lens part may be joined with each other or separate from each other with a distance therebetween. The primary path along which the heat is conducted is thus made of sapphire, quartz, calcium fluoride, or any other suitable material, allowing an increase in freedom in the choice of the material of the lens part. Furthermore, coupling the periphery of the planar plate part to a heat dissipating member made, for example, of copper allows an increase in the cooling performance. On the other hand, the lens part made of high-refractive-index, low-dispersion glass allows reduction in aberrations. When the planar plate part and the lens part face each other via curved surfaces, the fluorescence can be refracted by a greater amount, whereby the aberrations produced by the lens part can be reduced. When the planar plate part and the lens part are separate from each other with a distance therebetween, no heat is transferred to the lens part, so that heat-induced optical distortion is less likely to occur in the lens part.

The lens part may be configured to be moved in the form of eccentric rotation by using a hollow motor or any other drive source. The blue light can therefore be moved repeatedly in the diameter direction, the diagonal direction, the direction of one side, or any other direction in the region, of the wavelength converter, that is irradiated with the blue light. According to the configuration described above, the wavelength converter is scanned with the blue light, so that the heat generating area of the wavelength converter widens. The heat is thus dispersed, whereby the temperature of the wavelength converter can be lowered.

To alternatively maintain the distance between the wavelength converter and the optical element, phosphor particles with the particle diameter variation suppressed to about ±30% with respect to a primary particle diameter ranging from 30 μm to 150 μm may be arranged on an aluminum substrate in the wavelength converter, and caused to firmly adhere to the aluminum substrate with silicone or glass, and the optical element may be placed so as to be in contact with the upper surface of the resultant structure. In this case, in which the phosphor particles constitute the irregularities, when the fluorescence is reflected off the first surface of the optical element and then impinges on the phosphor particles, the traveling direction of the fluorescence changes at the surfaces of the phosphor particles. The same effects as those provided by the embodiments described above can thus be provided.

In addition to the above, the specific descriptions of the shapes, the numbers, the arrangements, the materials, and other factors of the components of the illuminator and the projector are not limited to those in the embodiments described above and can be changed as appropriate. The above embodiments have been described with reference to the case where the illuminator according to the present disclosure is incorporated in a projector using liquid crystal panels, but not necessarily. The illuminator according to the present disclosure may be used in a projector using a digital micromirror device as each of the light modulators. The projector may not include a plurality of light modulators and may instead include only one light modulator.

The aforementioned embodiments have been described with reference to the case where the illuminator according to the present disclosure is incorporated in a projector, but not necessarily. The illuminator according to the present disclosure may be used as a lighting apparatus, a headlight of an automobile, and other components.

An illuminator according to an aspect of the present disclosure may have the configuration below.

The illuminator according to the aspect of the present disclosure includes a light source that outputs first light that belongs to a first wavelength band, a wavelength converter that converts the first light into second light that belongs to a second wavelength band different from the first wavelength band, and an optical element that transmits the second light emitted from the wavelength converter. An air layer is provided between the wavelength converter and the optical element, and has a length along the direction of the optical axis of the optical element and greater than or equal to 0.3 μm but smaller than or equal to 9.0 μm. The optical element has a coefficient of linear expansion smaller than or equal to 65×10⁻⁷/° C. at temperatures ranging from 100° C. to 200° C., and a thermal conductivity greater than or equal to 1.0 W/m·K.

The illuminator according to the aspect of the present disclosure may further include a spacer that maintains the distance between the wavelength converter and the optical element.

In the illuminator according to the aspect of the present disclosure, the surface, of the wavelength converter, that faces the optical element may have irregularities.

In the illuminator according to the aspect of the present disclosure, the surface roughness of the surface may be greater than 0.05 μm but smaller than or equal to 0.2 μm.

The illuminator according to the aspect of the present disclosure may further include a heat dissipating member thermally coupled to the optical element.

In the illuminator according to the aspect of the present disclosure, the optical element may include a planar plate part and a lens part.

In the illuminator according to the aspect of the present disclosure, the planar plate part and the lens part may be separate parts.

The illuminator according to the aspect of the present embodiment may further include a reflection mirror that is provided at a portion of the lens part and reflects the second light emitted from the wavelength converter toward the wavelength converter.

A projector according to another aspect of the present disclosure may have the configuration below.

The projector according to the other aspect of the present disclosure includes the illuminator according to the aspect of the present disclosure, a light modulator that modulates light outputted from the illuminator and containing the second light in accordance with image information, and a projection optical apparatus that projects the light modulated by the light modulator.

What is claimed is:

1. An illuminator comprising:
a light source that emits first light that belongs to a first wavelength band;
a wavelength converter that converts the first light into second light that belongs to a second wavelength band different from the first wavelength band; and
an optical element that transmits the second light emitted from the wavelength converter,
wherein an air layer is provided between the wavelength converter and the optical element,
a length of the air layer along a direction of an optical axis of the optical element is greater than or equal to 0.3 μm but smaller than or equal to 9.0 μm, and
the optical element has a coefficient of linear expansion smaller than or equal to 65×10⁻⁷/° C. at temperatures ranging from 100° C. to 200° C., and a thermal conductivity greater than or equal to 1.0 W/m·K.

2. The illuminator according to claim 1, further comprising
a spacer that maintains a distance between the wavelength converter and the optical element.

3. The illuminator according to claim 1,
wherein a surface, of the wavelength converter, that faces the optical element has irregularities.

4. The illuminator according to claim 3,
wherein surface roughness of the surface is greater than or equal to 0.05 μm but smaller than or equal to 0.2 μm.

5. The illuminator according to claim 1, further comprising
a heat dissipating member thermally coupled to the optical element.

6. The illuminator according to claim 1,
wherein the optical element includes a planar plate part and a lens part.

7. The illuminator according to claim 6,
wherein the planar plate part and the lens part are separate parts from each other.

8. The illuminator according to claim 6, further comprising
a reflection mirror provided at a portion of the lens part, the reflection mirror configured to reflect the second light emitted from the wavelength converter toward the wavelength converter.

9. A projector comprising:
the illuminator according to claim 1;
a light modulator that modulates light emitted from the illuminator and containing the second light; and
a projection optical apparatus that projects the light modulated by the light modulator.
